(19) United States
(12) Patent Application Publication
(10) Pub. No.: US 2005/0243821 A1
(43) Pub. Date: Nov. 3, 2005

(54) Communication system and communication method

(75) Inventor: Tomofumi Iima, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 11/114,192

(22) Filed: Apr. 26, 2005

(30) Foreign Application Priority Data
Apr. 28, 2004 (JP) 2004-134387

(51) Int. Cl. H04L 12/56

(52) U.S. Cl. 370/389

(57) ABSTRACT

A communication system for transmitting/receiving data via a network line in frame, wherein the frame is transmitted/received using a first area in a preamble field of the frame as data to indicate the beginning of the frame, and a second area in the preamble field as a preamble information field having information.

### BACKGROUND OF THE INVENTION

1. Field of the Invention

The present invention relates to a communication method between communication terminals, and more particularly to a communication method for transferring data in frame.

2. Description of the Related Art

The application of communication methods based on Ethernet®, which has been developed as an access technology for LANs, is advancing. In Ethernet®, data is transmitted and received in frame. FIG. 5 is a diagram depicting a structure of a conventional frame used in Ethernet®. As FIG. 5 shows, a frame 500 is comprised of a preamble field 502 (PA), an address/data field 504 (DATA), and an FCS (Frame Check Sequence) field 505.

The PA field 502, which has 7 bytes, is a field to indicate the beginning of a frame. One byte just before the DATA field is called the SFD (Start Field Delimiter) field 503. The SFD field is a field to indicate the start part of the effective data. The address/data field 504 is a field to indicate the destination, transmission source address and content of the data. The FCS field 505 is a field to check whether the frame data is valid.

The PA field 502 in a conventional Ethernet® is a field to indicate the beginning of a frame, and to synchronize bits when frame transmission is started. Therefore in the conventional PA field 502, 1 and 0 are alternately repeated throughout 7 bytes. By this alternate repeat of 1 and 0, the receive side recognizes the beginning of the frame, and. synchronizes matching the repeat of 1 and 0 of this PA field 502. Then by the SFD 503 field, the receive side recognizes that the subsequent field is the data.

However along with the further increase in the speed of current networks, the above mentioned method of indicating the beginning of the frame and also synchronizing the data at the receive side is becoming unnecessary. In “IEEE Standards 802.3ae, 2002 46.2.2, Preamble and start of frame delimiter, pp. 253-254”, a method for switching the first 1 byte of the 7 byte field to a bit pattern called “Start Control Character” (hereafter SCC) to indicate the beginning of the frame is shown. According to this method, the first 1 byte of the PA field is the above mentioned SCC, and the remaining 6 bytes are the above mentioned repeat pattern of 1 and 0.

However in this method as well, the repeat signals of 1 and 0 are inserted throughout 6 bytes, even though synchronization is becoming unnecessary. Such simple repeat signals in the PA field results in the transmission and reception of data having no information.

As described above, a problem of the related art is that a data area having no information is included in the preamble of the frame data to be transmitted/received.

### SUMMARY OF THE INVENTION

A communication system for transmitting/receiving data via a network line in frame, wherein the frame is transmitted/received using a first area in a preamble field of the frame as data to indicate the beginning of the frame, and a second area in the preamble field as a preamble information field having information.

A communication method for transmitting/receiving data via a network line in frame units, and the frame is transmitted/received using a first area in a preamble field of the frame as data to indicate the beginning of a frame, and a second area in the preamble field as a preamble information field having information.

### BRIEF DESCRIPTION OF THE DRAWINGS

The above and other objects, advantages and features of the present invention will be more apparent from the following description taken in conjunction with the accompanying drawings, in which:

FIG. 1 shows a block diagram of a communication system of an embodiment.

FIG. 2 shows a structure of a frame.

FIG. 3A shows an example of a preamble field.

FIG. 3B shows an example of a preamble field.

FIG. 3C shows an example of a preamble field.

FIG. 3D shows an example of a preamble field.

FIG. 4 shows an divided example of a preamble field.

FIG. 5 shows a conventional frame used in Ethernet®.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

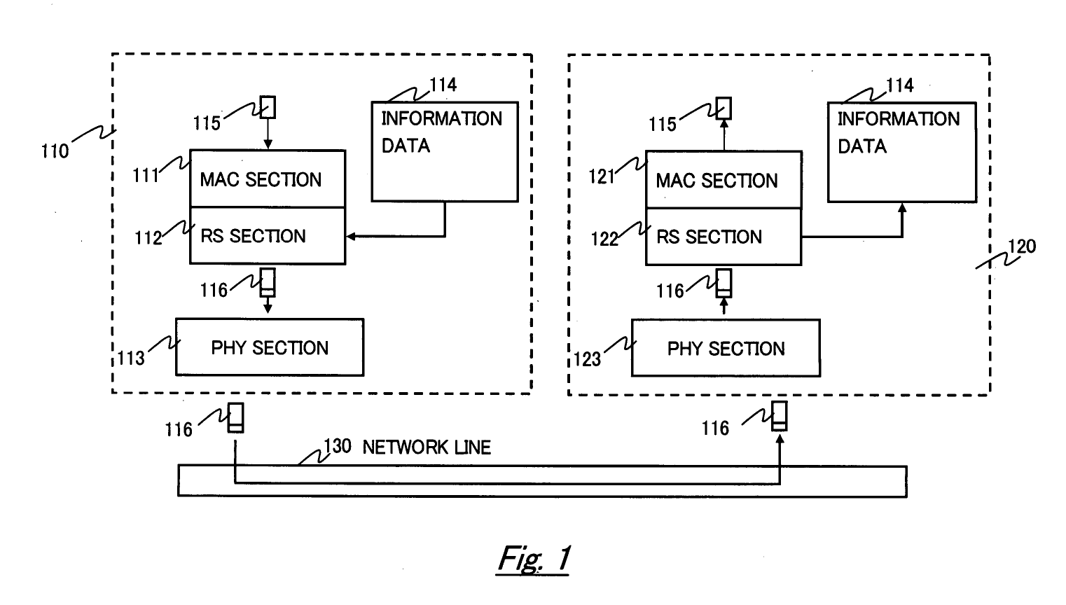

Embodiments of the present invention will now be described with reference to the drawings. FIG. 1 is a diagram depicting a configuration of the communication system according to an embodiment of the present invention. In the present embodiment, the first communication terminal and the second communication terminal will be described as an example of a communication system. The first communication terminal comprises a first communication control unit 110. The second communication terminal comprises a second communication control unit 120. The first and second communication control units 110 and 120 constitute the communication control unit which executes the communication method of the present invention.

The first and second communication control units 110 and 120 shown in FIG. 1 constitute the part for controlling the layers corresponding to the physical layer and the data link layer in the OSI (Open System Inter-connection) reference model.

As FIG. 1 shows, the first and second communication control units 110 and 120 comprise the MAC (Media Access Control) section 111, 121, the RS (Reconciliation Sub-layer) section 112, 122, and the PHY (Physical layer) section 113, 123 respectively. Also the first and second communication control units 110 and 120 are connected by a network line 130 for transmitting/receiving data in frame units. Now the operation and the communication method of each section of the communication system of the present invention will be described in detail using the transmission/receive of the frame data of an Ethernet® between the first communication terminal and the second communication terminal as an example.

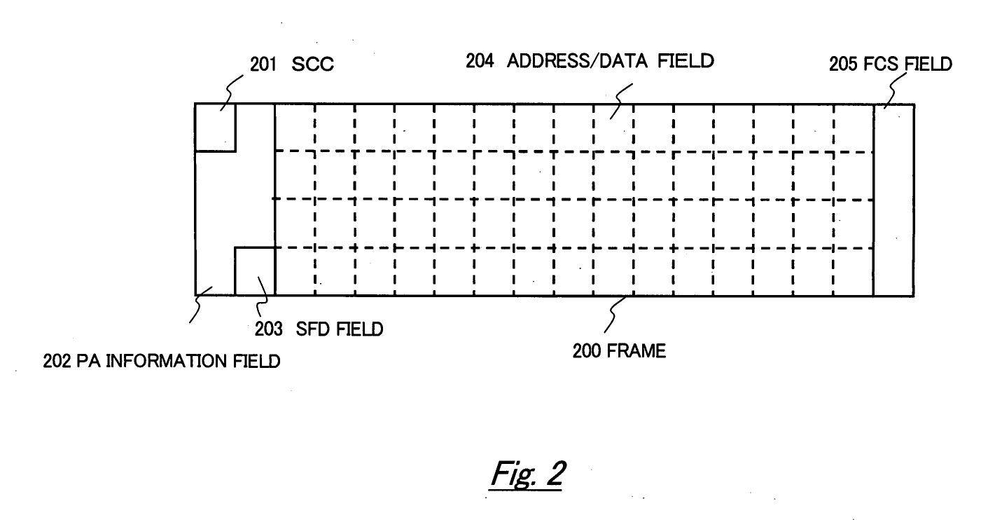

FIG. 2 is a diagram depicting a structure of a frame 200 to be transmitted/received in the present embodiment. The frame 200 according to this embodiment is a frame to be transferred at a 10 gigabits/second rate. The data signal line of this frame has a 32-bit width. This 32-bit width data is divided into 8-bit units, and is referred to as lane 0, lane 1, lane 2 and lane 3 respectively. The preamble field of the frame 200 of this embodiment has 7 bytes. This preamble field has a 1 byte Start Control Character (SCC) 201 as the first area, a later mentioned 6 bytes of preamble information field 202 as the second area. The frame 200 has a 1 byte SFD field 203 which follows the preamble field. The frame 200 further has an address/data field 204 and an FCS field 205.

A difference from the structure of a conventional frame is that the 6 bytes of preamble information field 202 is not the repeat pattern of 1 and 0, but is a preamble information field 202 which has information. In other words, the preamble information field is a data string based on some information, and meaningful information is written to this field. Hereafter the second area in this 6 bytes preamble field which has information is referred to as the PA information field 202.

Now the transmission operation will be described using the first communication control unit 110. The MAC section 111 of the first communication control unit 110 receives the data 115 corresponding to the information transmitted from the section located at a higher layer thereof. The MAC section 111 performs a calculation called CRC (Cyclic Redundancy Check) based on the provided data 115. The MAC section 111 attaches the data corresponding to this calculation result to the end of the received data 115. This calculation result data is data to be used for the receive side to detect whether the data is error free. This corresponds to the FCS field in FIG. 2. The MAC section 111 adds the data corresponding to the 7 bytes of preamble field and 1 byte of SFD field to the beginning of the received data 115. After attaching the data corresponding to the preamble field, the SFD field and the result of the CRC calculation to the data 115, the MAC section 111 sends the data 115 to the RS section 112.

In the RS section 112, the first 1 byte (first area) of the data corresponding to the preamble field of the data received from the MAC section 111 is rewritten to SCC. This SCC becomes the data to indicate the beginning of the frame for the communication terminal at the receive side (see FIG. 2). Also in the communication control unit 110 of this embodiment, the second area, excluding the SCC at the beginning of the preamble field, is rewritten by the RS section 112. In other words, the 6 byte area corresponding to the PA information field 202 in FIG. 2 is rewritten to 6 byte or less meaningful information data, shown as 114 in FIG. 1, instead of the repeat pattern 1 and 0. The RS section 112 sends the first 1 byte of the preamble field and the subsequent 6 byte rewritten data 115 in the PA information field to the PHY section 113 as the frame data 116.

The PHY section 113 converts the frame data 116, which has been sent in a parallel format thus far, into the frame data 116 in serial format. By this conversion, the frame data 116 can be transmitted via the network line 130. This frame data 116 in serial format is transmitted from the PHY section 113 via the network line 130.

Now the operation of the receiving data transferred by the second communication control unit 120 via the network line 130 will be described. The operation on receiving, a reverse process of the transmission operation, is essentially performed.

The frame data 116 in serial format is received by the PHY section 123 of the second communication control unit via the network line 130. The frame data 116 received by the PHY section 123 in serial format is converted into frame data 116 in parallel format. This frame data 116 in parallel format is sent to the RS section 122, which is a higher layer.

The RS section 122 rewrites the first 1 byte (first area corresponding to SCC) of the preamble field of the frame data 116 received from the PHY section 123 to the repeat pattern of 1 and 0. Also in the RS section 122 of the present embodiment, 6 byte or less data 114 is read from the second area which is subsequent to SCC. In other words, the information in the PA information field is read. This data in the PA information field, which is read, can be used by the receive side (second communication terminal 120) as the information attached by the transmission side. After rewriting the SCC and reading the data 114, the RS section 122 sends the received frame data 116 to the MAC section 121.

The MAC unit 121 deletes the first 8 bytes corresponding to the preamble field and the SFD field. Also CRC calculation is performed using the data 115 in the received frame. And the MAC section 121 compares the result of the CRC calculation from the received data 115 and the value indicated in the FCS field at the end of the frame. By this comparison, it is checked whether the received data 115 is error free, and the data 115 is sent to a higher layer.

As described above, according to the communication system of the present embodiment, meaningful information, which is not a repeat data for synchronization, can be transmitted/received using the PA information field between SCC to indicate the beginning of the frame and the SFD field to indicate the start of the data field. Conventionally the PA field is also the field to indicate the beginning of the frame, according to the present invention, the first 1 byte of the PA field is rewritten to SCC in the RS layer section in the communication control unit 110 (120) during communication, so the PA field can be rewritten to the PA information field which has information without losing the function to indicate the beginning of the frame. By the communication method having the PA information field using this communication system, a communication method with better transmission efficiency can be executed. The first communication control unit 110 can perform a same receive operation as the second communication control unit 120, and the second communication control unit 120 can perform a same transmission operation as the first communication control unit 110. The description of these operations, which are the same as described above, are omitted.

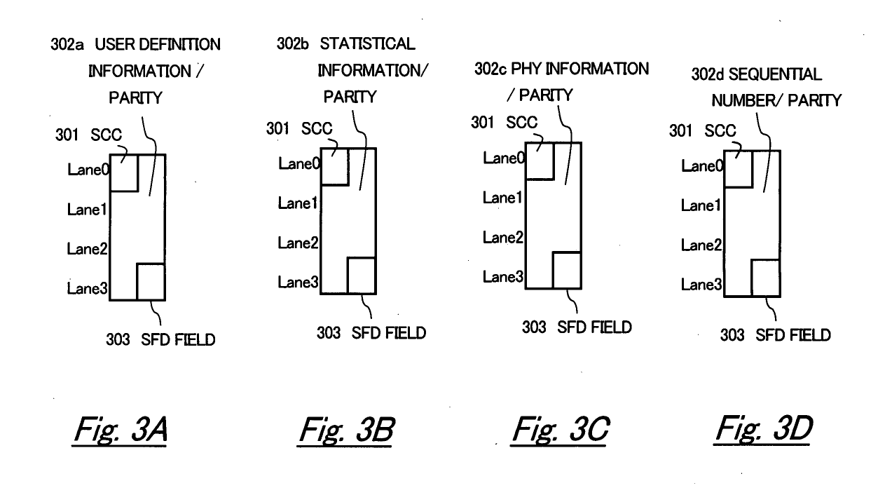

FIG. 3A-FIG. 3D are diagrams depicting the information to be written to the PA information field in the present embodiment. In FIG. 3, only the preamble field (first 7 bytes) and the SFD field of the frame shown in FIG. 2 is shown, and the address/data field and the FCS field are omitted.

In the PA information field 302a shown in FIG. 3A, information on user definition and the parity thereof can be written. In this case, by the receive side receiving the user definition information and parity thereof, the original data, which is set by the transmission side, can be received by the receive side.

In the PA information field 302b shown in FIG. 3B, the statistical information of the frames which were transmitted/received and the parity thereof can be written. By the receive side receiving the statistical information and the parity thereof, the statistics on history of the frames transmitted/received between the two MAC sections can be judged. In this case, the statistics on the history indicates the size and the number of transmitted/received frames. As the statistics of the history, the number of transmitted or received frames including errors, and the number of transmitted or received frames having a certain characteristics, may be indicated.

As the data written in the PA information field 302c shown in FIG. 3C, the PHY information and the parity thereof can be written. By the receive side receiving the PHY information and the parity thereof, information on the PHY section (113, 123), which positions below the MAC section (111, 121) or the RS section (112, 122) collected by the MDIO interface, can be acquired, so the status of the PHY section (113, 123) can be judged. The MDIO interface is an interface dedicated to the exchange of data with the PHY section specified by standards.

As the data to be written to the PA information field 302d shown in FIG. 3D, the sequential number and the parity thereof can be allocated. By the receive side receiving the sequential information and the parity thereof, the order relation of the transmitted frame can be judged.

In the PA information field shown in FIG. 3A-FIG. 3D, parity is data to be attached for the receive side to check whether an error occurred to the transmission information, and by writing parity in the PA information field, the validity of the received information in the PA information field can be confirmed.

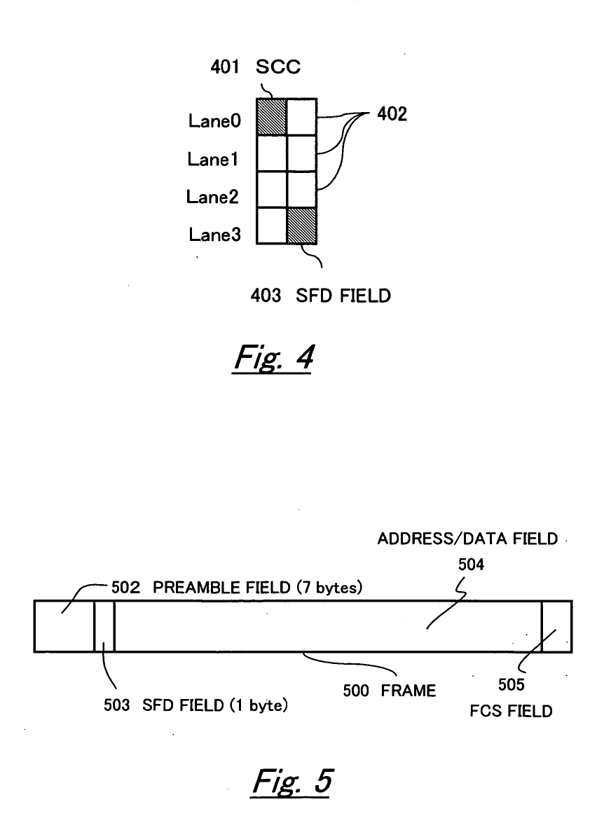

FIG. 4 is a diagram depicting the further division of the PA information field so as to write a plurality of information as described above. The PA information field 402 corresponding to the second area of the preamble field shown in FIG. 4 may be further divided into a plurality of areas so as to write different information to each area.

In the present embodiment, the configuration of the RS section of the second communication terminal at the receive side, where the information in the PA information field can be read, was shown, but if the RS section of the receive side does not have this read function, the configuration of the RS section of the communication terminal at the transmission side may be switchable, so that a frame data corresponding to a conventional preamble field is transmitted without rewriting the PA information field.

It is apparent that the present invention is not limited to the above embodiment, that may be modified and changed without departing from the scope and spirit of the invention.

1. A communication system for transmitting/receiving data via a network line in frame, wherein the frame is transmitted/received using a first area in a preamble field of the frame as data to indicate the beginning of the frame, and-a second area in the preamble field as a preamble information field having information.

2. The communication system according to claim 1, wherein the communication system further comprises a communication control unit for transmitting the frame, the communication control unit rewrites the first area in the preamble field to the data to indicate the beginning of the frame, and rewrites the second area in the preamble field to the preamble information field having information.

3. The communication system according to claim 2, wherein the communication control unit further comprises a MAC layer section for attaching a predetermined preamble field to the transmission data, and an RS layer section for rewriting the first area in the preamble field to the data to indicate the beginning of the frame and rewriting the second area in the preamble field to the preamble information field having information.

4. The communication system according to claim 2, wherein the communication control unit receives the frame via the network line, and reads the information of the preamble information field from the preamble information field in the frame.

5. The communication system according to claim 4, wherein the communication control unit further comprises an RS layer section for rewriting data to indicate the beginning of the first area in the preamble field and reading information written to the preamble information field, and a MAC layer section for removing the preamble field from the receive data.

6. The communication system according to claim 1, wherein the first area is the first 1 byte of the preamble field, and the second area is an area of the preamble field after removing the last 1 bytes and the first area.

7. A communication method for transmitting/receiving data via a network line in frame, and the frame is transmitted/received using a first area in a preamble field of the frame as data to indicate the beginning of a frame, and a second area in the preamble field as a preamble information field having information.
